(19) United States
(12) Patent Application Publication
(10) Pub. No.: US 2014/0337420 A1
(43) Pub. Date: Nov. 13, 2014

(54) System and Method for Recording Music Which Allows Asynchronous Collaboration over the Internet

(71) Applicants: Brian Lee Wentzloff, Memphis, TN (US); Vincent Ross Rogers, Memphis, TN (US); Justin Charles Olita, Collierville, TN (US)

(72) Inventors: Brian Lee Wentzloff, Memphis, TN (US); Vincent Ross Rogers, Memphis, TN (US); Justin Charles Olita, Collierville, TN (US)

(21) Appl. No.: 13/890,980

(22) Filed: May 9, 2013

(51) Int. Cl. H04L 29/06

(52) U.S. Cl. CPC H04L 65/403
USPC 709/204

(57) ABSTRACT

A system for recording music is disclosed. The system for recording music comprises an audio plug-in, wherein the plug-in is configured to be incorporated to a computer having a digital audio workstation, wherein the plug-in allows for asynchronous collaboration of a plurality of audio files recorded by a plurality of collaborators, wherein the audio files are transmitted and received among the plurality of collaborators via the Internet. A method for recording music is additionally disclosed. The method for recording music comprises the following steps: (a) uploading a plug-in to a computer having a digital audio workstation, wherein the plug-in allows for asynchronous collaboration of a plurality of audio files recorded by a plurality of collaborators, wherein the audio files are transmitted and received among the plurality of collaborators via the Internet; (b) recording a first audio file on digital audio workstation; (c) submitting the audio file to at least one collaborator via the Internet; (d) receiving a second audio file via the Internet; and (e) incorporating the second audio file into the digital audio workstation.

### FIELD

The present disclosure relates generally to a system and method for recording music which allows asynchronous collaboration amongst multiple collaborators over the Internet.

### BACKGROUND

Technology in the music recording industry is generally tailored to the synchronous recording of music. Namely, music recording technology is typically used to record the music contemporaneously while its created by musicians who are all in the same room at the same time with one computer. Recently, there has been progress in music recording technology which allows computers to work together over local area networks to accomplish musical recordings, thus allowing musicians the freedom and benefit of using multiple locations. However, such technology is geared toward low latency, “real-time” collaboration. Such technology is limited to local area networks and does function over the Internet.

Some have attempted to remedy the need in the music recording industry for collaboration amongst musicians over the Internet by writing recording software but such recording software is often not capable of being integrated with existing recording software, which is well known and used in the industry. Such lack of integration of any new recording software is both costly and high inconvenient as recording software is highly technical and complicated, and the time and cost involved in learning such software is significant.

A system and method for recording music which allows asynchronous collaboration amongst a plurality of collaborators over the Internet is needed. Moreover, a system and method for recording music which allows asynchronous collaboration over the Internet wherein such system and method is capable of being integrated and used with existing recording software is also needed.

### BRIEF SUMMARY

A system for recording music is disclosed. The system for recording music comprises an audio plug-in, wherein the plug-in is configured to be incorporated to a computer having a digital audio workstation, wherein the plug-in allows for asynchronous collaboration of a plurality of audio files recorded by a plurality of collaborators, wherein the audio files are transmitted and received among the plurality of collaborators via the Internet. A method for recording music is additionally disclosed. The method for recording music comprises the following steps: (a) uploading a plug-in to a computer having a digital audio workstation, wherein the plug-in allows for asynchronous collaboration of a plurality of audio files recorded by a plurality of collaborators, wherein the audio files are transmitted and received among the plurality of collaborators via the Internet; (b) recording a first audio file on digital audio workstation; (c) submitting the audio file to at least one of collaborator via the Internet; (d) receiving a second audio file via the Internet; and (e) incorporating the second audio file into the digital audio workstation.

### BRIEF DESCRIPTION OF THE DRAWINGS

The present disclosure will be better understood by reference to the following detailed description when considered in conjunction with the accompanying drawings wherein:

FIG. 1 is a flow diagram depicting the system and method for recording music which allows asynchronous collaboration over the Internet according to one embodiment.

### DETAILED DESCRIPTION

In one embodiment, the system and method for recording music which allows asynchronous collaboration over the internet comprises an audio plug-in. A audio plug-in comprises a set of software components that adds or enhances audio related functionality to a larger audio software application (or audio host application). Audio related functionality may include digital signal processing or sound synthesis. In one embodiment, an audio plug-in may be supported by the audio host application which allows the audio plug-in to customize the functionality of the host application. Typically, audio plug-ins do not function by themselves but are dependent on the services provided by the host application. Conversely, the audio host application may operate independently of the plug-ins, which allows end-users to add and/or update plug-ins dynamically without making changes to the audio host application. In one embodiment, plug-ins may also be referred to as add-ons, snap-ins, extensions and/or themes for software applications.

Larger software applications or host applications support plug-ins for several reasons including (1) to support the ability to easily add new features and (2) to enable third party developers to create functionalities which extend beyond those functions provided by such software application.

In one embodiment, an audio plug-in communicates with the host application which provides services which the plug-in can use. In one embodiment, services provided by the host application may include a means for the plug-in to register with the host application and a protocol for the exchange of data between the plug-in and host applications. Third parties use open application programming interfaces (APIs) to create plug-ins that interact with the host application.

In one embodiment, the system and method for recording music which allows asynchronous collaboration over the internet incorporates an audio plug-in comprising an application programming interface which determines communication between the audio host application and the audio plug-in. In one embodiment, the application programming interface is used to control and visualize the plug-in's audio parameters. In one embodiment, the audio plug-in comprises an interface for integrating software audio synthesizer and effect plug-ins with audio editors and hard-disk recording systems.

In one embodiment, the system and method for recording music which allows asynchronous collaboration over the Internet comprises an audio plug-in which collaborates with a digital audio workstation comprising an audio host application. In another embodiment, the system and method for recording music disclosed herein includes an audio plug-in having an interface for capturing a musical contribution or project recorded and edited by one user locally on a computer having a digital audio workstation and sending the contribution or project via the Internet to a second user thus allowing asynchronous collaboration. The audio plug-in includes an interface which allows a first collaborator or user located in a first geographical area to sends audio files and/or metadata to cloud servers. In another embodiment, the audio plug-in comprises an interface which notifies a second and/or more collaborators (or users) which have been invited to collaborate with the first collaborator that the audio files and metadata submitted by the first collaborator are being transmitted and capable of being received by the second and/or more collaborators. In a further embodiment, the audio plug-in comprises an interface which allows the participating collaborators to receive audio files and metadata from the cloud servers and incorporate such files into the digital audio workstation functioning on each collaborator's computer.

In one embodiment, the system and method for recording music which allows asynchronous collaboration over the internet comprises an audio host application which may include a plug-in host which allows a audio plug-in to be loaded and controlled. In one embodiment, the host application provides multiple services including handling the routing of digital audio and musical instrument digital interface to and from the audio plug-in. In one embodiment, the audio host application may be ProTools, Logic Pro, REAPER, FruityLoops, GarageBand and Reason, but any other host application may be used as desired by one of skill in the art.

In one embodiment, stand-alone dedicated host applications may be used as desired by one of skill in the art. A stand-alone dedicated host application may serve solely as a host of the plug-in but does not function as an extension of the plug-ins sequencing or audio capabilities. In still a further embodiment, a hardware device may function as the host application. Such hardware device may be portable and usable without a computer, although some may require a computer for editing purposes.

In another embodiment, host application comprises an interface which is the point of interaction between the host application and the plug-in.

In one embodiment, musical instrument digital interface includes a protocol, digital interface and connectors which allow a wide variety of electronic musical instruments, computers and other related devices to connect and communicate with one another.

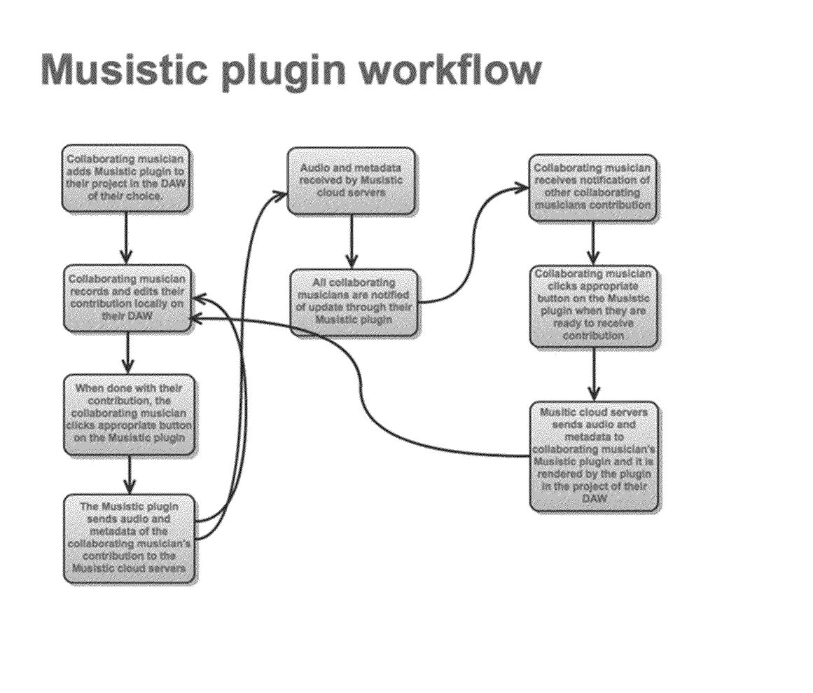

Referring to FIG. 1, in one embodiment, the system and method for recording music which allows asynchronous collaboration over the internet comprises a first collaborating musician adding or loading the audio plug-in to a project in the digital audio workstation. The collaborating musician may record and edit an audio contribution (comprising audio files and metadata) locally on the digital audio workstation. When the collaborating musician has completed the recording and editing (if needed) of his contribution, the collaborating musician directs the plugin to send the audio files and metadata of his contribution to cloud servers. The cloud servers receive the audio files and meta data. Once data is received by the cloud servers from one collaborating musician, a notification is sent to all collaborating musicians by way of the audio plug-in notifying all collaborating musicians that have registered for a certain project that a contribution from one collaborating musician is ready to be received. Collaborating musicians may then direct the receipt of the contribution from the cloud servers to the audio plug-in. The contribution may then be incorporated into the project of the digital audio workstation.

In one embodiment, cloud servers may store all received audio files and metadata allowing such files and data to be saved as well as to be accessed in the future.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the disclosed invention and equivalents thereof. The foregoing disclosure accounts for any and all current or future advances in technology, known or unknown, in perpetuity, across any platform, service, device or medium of interface known or unknown, in perpetuity.

What is claimed is:

1. A system for recording music comprising:
an audio plug-in, wherein the plug-in is configured to be incorporated to a computer having a digital audio workstation, wherein the plug-in allows for asynchronous collaboration of a plurality of audio files recorded by a plurality of collaborators, wherein the audio files are transmitted and received among the plurality of collaborators via the Internet.

2. A method for recording music comprising:
a. uploading a plug-in to a computer having a digital audio workstation, wherein the plug-in allows for asynchronous collaboration of a plurality of audio files recorded by a plurality of collaborators, wherein the audio files are transmitted and received among the plurality of collaborators via the Internet;
b. recording a first audio file on digital audio workstation;
c. submitting the audio file to at least one collaborator via the Internet;
d. receiving a second audio file via the Internet; and
e. incorporating the audio file into the digital audio workstation.

3. The method of claim 2, wherein step (b) comprises editing the contribution on digital audio workstation.
